(19) United States
(12) Patent Application Publication
(10) Pub. No.: US 2008/0066136 A1
(43) Pub. Date: Mar. 13, 2008

(54) System and method for detecting topic shift boundaries in multimedia streams using joint audio, visual and text cues

(75) Inventors: Chitra Dorai, Chappaqua, NY (US); Robert G. Farrell, Cornwall, NY (US); Ying Li, Mohegan Lake, NY (US); Youngja Park, Edgewater, NJ (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/509,250

(22) Filed: Aug. 24, 2006

(51) Int. Cl. G06F 3/00; G06F 13/00; H04N 7/16; H04N 5/445

(52) U.S. Cl. 725/135; 725/45

(57) ABSTRACT

Computer implemented method, system and computer usable program code for detecting topic shift boundaries in a multimedia stream. A computer implemented method for detecting topic shift boundaries in a multimedia stream includes receiving a multimedia stream, and performing multimodal analysis on the multimedia stream to locate a plurality of temporal positions within the multimedia stream at which topic changes have an increased likelihood of occurring to provide a sequence of multimedia portions. Characteristics for a sliding window for each multimedia portion in the sequence of multimedia portions are automatically determined, and topic shift boundaries are detected in each multimedia portion by applying a text-based topic shift detector over the media stream's text transcript using a sliding window, wherein the sliding window used with each multimedia portion has the characteristics determined from its respective multimedia portion.

This invention was made with Government support under Contract No.: W91CRB-04-C-0056 awarded by Army Research Office (ARO). The Government has certain rights in this invention.

### BACKGROUND OF THE INVENTION

1. Field of the Invention

The present invention relates generally to the field of multimedia content analysis and, more particularly, to a computer implemented method, system and computer usable program code for detecting topic shift boundaries in multimedia streams using joint audio, visual and text information.

2. Description of the Related Art

As the amount of multimedia information available online grows, there is an increasing need for scalable, efficient tools for content-based multimedia search and retrieval, navigation, summarization, and management. Because video and audio are time-varying, finding information quickly in these types of linear multimedia streams is difficult.

One solution to the problem of finding information in a multimedia stream is to partition the stream into segments by identifying topic shift boundaries so that each segment will relate to one topic. Users can then quickly locate those portions of the multimedia stream that contain desired topics. This solution is also useful for content-based browsing, reuse, summarization, and a host of other applications of multimedia.

Topic shift detection has been widely studied in the area of text analysis, which is usually referred to as text segmentation. However, finding topic shifts in a multimedia stream is rather difficult as topic shifts can be indicated singly or jointly by many different cues that are present in the multimedia stream such as changes in its audio track or visual content (e.g. slide content changes).

Most topic shift detection algorithms for text recognize topic shifts based on lexical cohesion or similarity. These techniques compute the lexical similarities between two adjacent textual units by counting the number of overlapping words or phrases, and conclude that there is a topic shift if the lexical similarity is significantly low. In most cases, a sliding window will be applied to determine the adjacent textual units. This approach however, suffers from two principal problems:
1) difficulty in determining the right window size; and
2) difficulty in determining the extent of window overlap.

The first problem directly affects the accuracy of detecting where the topic shifts occur as too large a window size tends to under-segment the document in terms of topic boundaries, and too small a window size leads to too many topic shifts being detected. The second problem of window overlap affects the position of the topic boundary, which is also known as a “localization” problem. In known algorithms, these two parameters are not adaptive to the size of the document or to the content of the document itself, i.e. they are fixed prior to execution of the algorithm.

Some techniques similar to those used in analyzing text have been applied to analyze transcripts of video streams for detecting topic changes in the streams; however, those techniques usually do not analyze audio and video streams to identify useful audiovisual “cues” to assist in identifying topic shift boundaries. In other words, the analysis process remains purely text based. There are some other techniques that indeed apply joint audio, visual, and text information in video topic detection, yet the topics to be detected are usually pre-fixed (e.g., financial, talk-show, and news topics), which are assigned to segments using joint probabilities of occurrences of visual features (e.g., faces), pre-categorized keywords and the like.

There is, accordingly, a need for a mechanism for detecting topic shift boundaries in multimedia streams that avoids the problems associated with the use of sliding windows in the text stream for determining the adjacent multimedia units, so as to improve the accuracy of topic shift boundary detection, and identify topics that are not pre-fixed.

### SUMMARY OF THE INVENTION

Exemplary embodiments provide a computer implemented method, system and computer usable program code for detecting topic shift boundaries in a multimedia stream. A computer implemented method for detecting topic shift boundaries in a multimedia stream includes receiving a multimedia stream, and performing multimodal analysis on the multimedia stream to locate a plurality of temporal positions within the multimedia stream at which topic changes have an increased likelihood of occurring to provide a sequence of multimedia portions. Characteristics for a sliding window for each multimedia portion in the sequence of multimedia portions are determined, and the topic shift boundaries are detected for each multimedia portion by applying a text-based topic shift detector over the media stream's text transcript using a sliding window, wherein the sliding window used with each multimedia portion has the characteristics specially determined from its respective multimedia portion.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an exemplary embodiment when read in conjunction with the accompanying drawings, wherein:

FIG. 1 depicts a pictorial representation of a network of data processing systems in which exemplary embodiments may be implemented;

FIG. 2 is a block diagram of a data processing system in which exemplary embodiments may be implemented;

FIG. 3 is a block diagram of a processing system for detecting topic shift boundaries in a video stream using joint audio, visual and text information from the video stream according to an exemplary embodiment;

FIG. 4 is a block diagram that illustrates a system for identifying text cues from a video stream according to an exemplary embodiment;

FIG. 5 is a block diagram that illustrates a system for identifying audio cues from a video stream according to an exemplary embodiment;

FIG. 6 is a block diagram that illustrates a system for identifying visual cues from a video stream according to an exemplary embodiment;

FIG. 7 is a diagram that schematically illustrates a mechanism for determining optimal sliding window characteristics for detecting topic shift boundaries in a video stream according to an exemplary embodiment; and

FIG. 8 is a flowchart that illustrates a method for detecting topic shift boundaries in a video stream using joint audio, visual and text information according to an exemplary embodiment.

### DETAILED DESCRIPTION OF THE PREFERRED EMBODIMENT

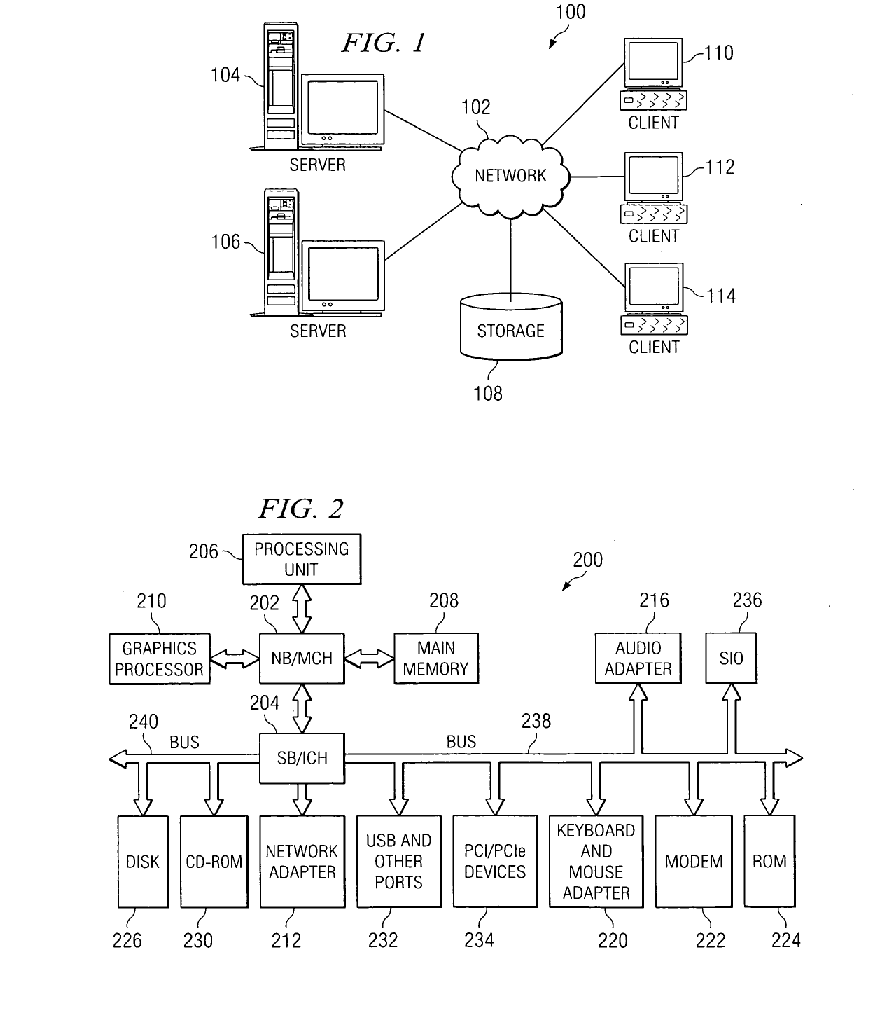

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which exemplary embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which exemplary embodiments may be implemented. Data processing system 200 is an example of a computer, such as server 104 or client 110 in FIG. 1, in which computer usable code or instructions implementing the processes may be located for the exemplary embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java programming system, may run in conjunction with the operating system and provides calls to the operating system from Java programs or applications executing on data processing system 200 (Java and all Java-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

Exemplary embodiments provide a computer implemented method, system and computer usable program code for automatically detecting topic shift boundaries in a multimedia stream, such as a video stream having an audio track and associated text transcript, by using joint audio, visual and text information from the multimedia stream. A multimodal analysis of the multimedia stream is applied to locate temporal positions within the stream at which topic changes have an increased likelihood of occurring. This analysis results in a sequence of multimedia portions across whose boundaries the topics are more likely to shift. A text-based topic shift detector is then applied to the video transcript within each portion using a sliding window having characteristics, such as window size and window overlap, that are dynamically determined based on current portion information. By providing potential topic change boundaries with multimodal analysis, and by using this information to determine optimized window characteristics for the topic shift detector, meaningful topic shift boundaries can be obtained with reduced false positive and false negative rates.

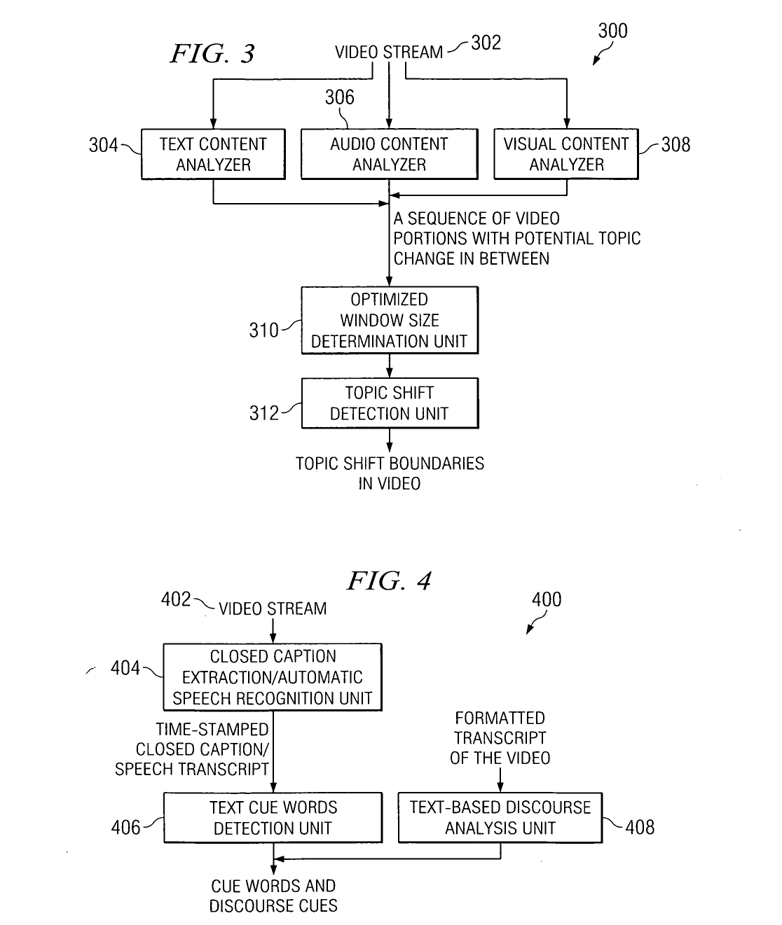

FIG. 3 is a block diagram of a processing system for detecting topic shift boundaries in a video stream using joint audio, visual and text information from the video stream according to an exemplary embodiment. In particular, FIG. 3 illustrates an overall framework by which audio, visual and text analysis tools are applied to analyze a video stream. The processing system is generally designated by reference number 300, and in the exemplary embodiment illustrated in FIG. 3, is a processing system for detecting topic shift boundaries in received video stream 302. It should be understood, however, that a video stream is intended to be exemplary only as topic shift boundaries can also be detected in other types of multimedia streams according to exemplary embodiments. For instance, it could also be a pure audio stream, in which case, however, analysis of visual cues (as described later) will be neglected. It could also be an animation sequence with voice-over audio in which case, visual cues would only be extracted from individual images as part of the animation but the audio track could be analyzed as described in this exemplary embodiment. Multimedia streams can also be produced by executing an algorithm or interactive service, such as a game or simulation. However, only the history or trace of the interaction would constitute a multimedia stream for the analysis.

As illustrated in FIG. 3, video processing system 300 includes text content analyzer 304 for analyzing textual content of video stream 302, audio content analyzer 306 for analyzing audio content of video stream 302, and visual content analyzer 308 for analyzing visual content of video stream 302. Analyzers 304, 306 and 308 analyze video stream 302 to recognize various cues in the video stream, and identify temporal positions in the video stream at which topic changes have an increased likelihood of occurring based on the results of the analyses. Among such cues that may be recognized include, for example: 1) the appearance of cue words or phrases such as “however”, “on the other hand”, etc. recognized by text content analyzer 304; 2) the presence of long periods of silence, periods of music, variations in pitch range or other prosodic features in the audio track, and changes in speakers recognized by audio content analyzer 306; and 3) changes of visual content that contains scene text such as presentation slides or information displays recognized by visual content analyzer 308. In addition, and as will be described hereinafter, cues relating to macro-segment boundaries will also help in identifying those temporal positions. Note that the detection of macro-segment boundaries itself can be achieved using joint audio, visual and text analysis.

The various cues recognized by text, audio and visual content analyzers 304, 306 and 308 are used to identify a plurality of temporal positions in video stream 302. Functions of the identified positions are two fold: 1) the positions themselves could be potential topic change boundaries; and 2) the positions naturally divide the entire video stream into portions such that optimized window size determination unit 310 can dynamically determine an optimum text analysis sliding window size for each portion such that topic shift detection unit 312 can accurately detect topic shift boundaries in video stream 302. In particular, by using an optimized window size for each portion of the video stream, the accuracy of topic shift boundary detection tends to be improved as compared to using a fixed window size for the entire video stream.

FIG. 4 is a block diagram that illustrates a system for identifying text cues from a video stream according to an exemplary embodiment. The system is generally designated by reference number 400, and may be implemented as text content analyzer 304 in FIG. 3. System 400 generally includes closed caption extraction/automatic speech recognition unit 404, text cue words detection unit 406 and text-based discourse analysis unit 408.

Closed caption extraction/automatic speech recognition unit 404 receives video stream 402 and generates a time-stamped transcript of textual content of the video stream. In particular, the time-stamped transcript can be generated using closed caption extraction procedure if closed captioning is available from the video stream, or using speech recognition procedure if closed captioning is not present, although it should be understood that it is not intended to limit the exemplary embodiments to any particular manner of generating the transcript, as either or both procedures can be used if desired.

In addition to the time-stamped transcript, a formatted text obtained from a transcription of the video stream could also be available. The formatted transcription preferably comprises a well-formatted transcript in the sense that it is organized into chapters, sections, paragraphs, etc. This can be readily achieved, for example, if the transcript is provided by a third party professional transcriber or the video producer, although it is not intended to limit the exemplary embodiments to creating the formatted transcription in any particular manner.

Text cue words detection unit 406 detects cue words and/or phrases in the time-stamped transcript. As indicated previously, such cue words or phrases could be “however”, “on the other hand”, and the like, that might suggest a topic change in video stream 402. At the same time, text-based discourse analysis unit 408 utilizes the formatted transcription, if available, to extract discourse cues including transitions between chapters, sections and paragraphs. Such discourse cues can be very useful in identifying topic changes in the video stream as they identify places where topic changes are particularly likely to occur.

The cue words and/or phrases detected by text cue words detection unit 406 and the discourse cues extracted by text-based discourse analysis unit 408 are output from their respective units as shown in FIG. 4.

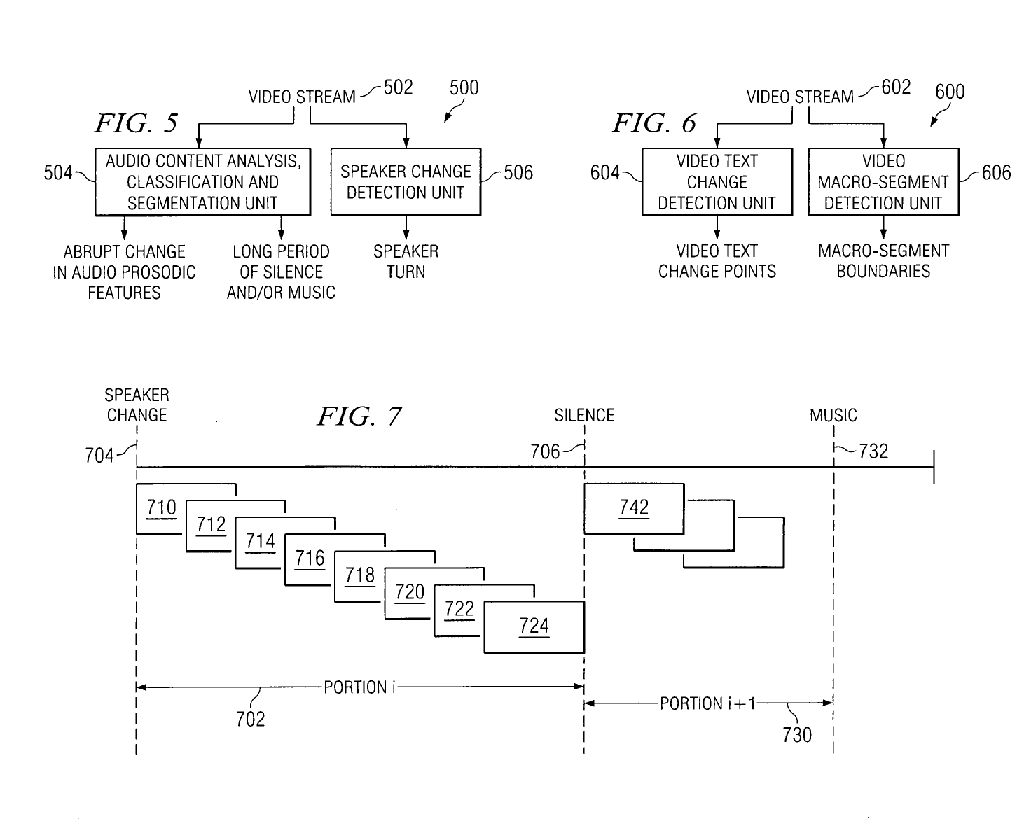

FIG. 5 is a block diagram that illustrates a system for identifying audio cues from a video stream according to an exemplary embodiment. The system is generally designated by reference number 500, and may be implemented as audio content analyzer 306 in FIG. 3.

System 500 generally includes audio content analysis, classification and segmentation unit 504 and speaker change detection unit 506. Audio content analysis, classification and segmentation unit 504 detects abrupt changes in audio prosodic features, and long periods of silence and/or periods of music in video stream 502; and speaker change detection unit 506 detects speaker changes in video stream 502.

Audio content analysis, classification and segmentation unit 504 attempts to locate those temporal instances (or time points) which follow immediately after a long period of silence and/or a period of music in video stream 502, or when there is a distinct change in certain audio prosodic features such as pitch range, as these are places where new topics are very likely to be introduced in the video stream. The speaker change detection unit 506 identifies changes in the speaker that may signal a shift in topic.

FIG. 6 is a block diagram that illustrates a system for identifying visual cues from a video stream according to an exemplary embodiment. The system is generally designated by reference number 600, and may be implemented as video content analyzer 308 in FIG. 3. System 600 generally includes video text change detection unit 604 and video macro-segment detection unit 606.

System 600 identifies visual cues which may indicate a possible topic change by analyzing the visual content of video stream 602. Video text change detection unit 604 locates places in video stream 602 where video text changes (the term “video text” as used herein includes both text overlays and video scene texts). In the case of instructional or informational videos in particular, a change of these texts, which usually appear as presentation slides or information displays, often corresponds to a subject change.

Video macro-segment detection unit 606 identifies macro-segment boundaries in video stream 602, wherein a “macro-segment” is defined as a high-level video unit which not only contains continuous audio and visual content, but is also semantically coherent. Although illustrated in FIG. 6 as being incorporated in visual cue identification system 600, it should be understood that video macro-segment detection unit 606 may identify macro-segment boundaries using joint audio, visual and text analysis. Macro-segment detection unit 606 is described in greater detail in commonly assigned, copending application Ser. No. 11/210,305 filed Aug. 24, 2005, and entitled “System and Method for Semantic Video Segmentation Based on Joint Audiovisual and Text Analysis”, the disclosure of which is incorporated herein by reference. As described in the copending application, “macro-segments” are semantic units relating to a thematic topic that are created by detecting and merging a plurality of groups of semantically related and temporally adjacent homogeneous units (referred to as “micro-segments”) in accordance with results of audio and visual analysis and keyword extraction.

Referring back to FIG. 3, all of the various cue information obtained from the entire video stream by text, audio and visual analyzers 304, 306 and 308 are combined to provide a sequence of concurrent video portions of the video stream with potential topic changes in between. An optimized window size for topic shift detection for each video portion is then determined using optimized window size determination unit 310, and topic shift detection unit 312 is then applied to video transcript to identify all topic change boundaries in the video stream using a sliding window of optimized size for each video portion. Topic shift detection unit 312 may be a known topic shift detector as currently used in mechanisms for detecting topic shifts in text. For instance, the TextTiling is a well known technique for automatically subdividing text documents into coherent multi-paragraph units which correspond to a sequence of subtopical passages.

FIG. 7 is a diagram that schematically illustrates a mechanism for determining optimal sliding window characteristics for detecting topic shift boundaries in a video stream according to an exemplary embodiment. In particular, given the temporal duration of each video portion (which can be different for different portions), optimized window characteristics are dynamically determined for each video portion. According to an exemplary embodiment, an optimized window size is calculated for each video portion on the condition that the last window that fully resides within a portion will not cross the boundary of the portion. This can be achieved, for example, by properly adjusting the overlap between two consecutive windows of selected size. One example for doing this is shown in FIG. 7 where video portion 702 of a video stream (also referred to as portion i), is shown to contain eight overlapping sliding windows (or more precisely, window locations) 710-724 extending between boundary 704 defining the beginning of portion 702 and boundary 706 defining the end of portion 702. As also shown in FIG. 7, boundary 704 is signified by a speaker change, and boundary 706 is signified by the end of a period of silence, although this is intended to be exemplary only of ways by which the boundaries may be signified.

By properly selecting the size of the window and/or the amount by which adjacent windows overlap with one another, the last window 724 of the eight sliding windows is completely within portion 702 as defined by boundary 706 defining the end of portion 702, and ends precisely at boundary 706. Then for the next video portion 730 in the video stream that follows portion 702 (also referred to as “portion i+l”), a new window size and/or amount of overlap between adjacent windows is calculated in a similar manner, such that the first window 742 of a plurality of sliding windows in portion 730 (which may be a different number than the number of sliding windows in portion 702) will start at beginning boundary 706 and end at ending boundary 732 (which, in the exemplary embodiment, is signified by the end of a period of music).

It should be noted that although it is possible that the topic in the video stream will remain the same across boundary 706 between portions 702 and 730 when the content in window 724 is compared against the content in window 742 using a topic shift detector such as topic shift detection unit 312 in FIG. 3, there is no overlap between these two “edge” windows so as to avoid raising a false alarm.

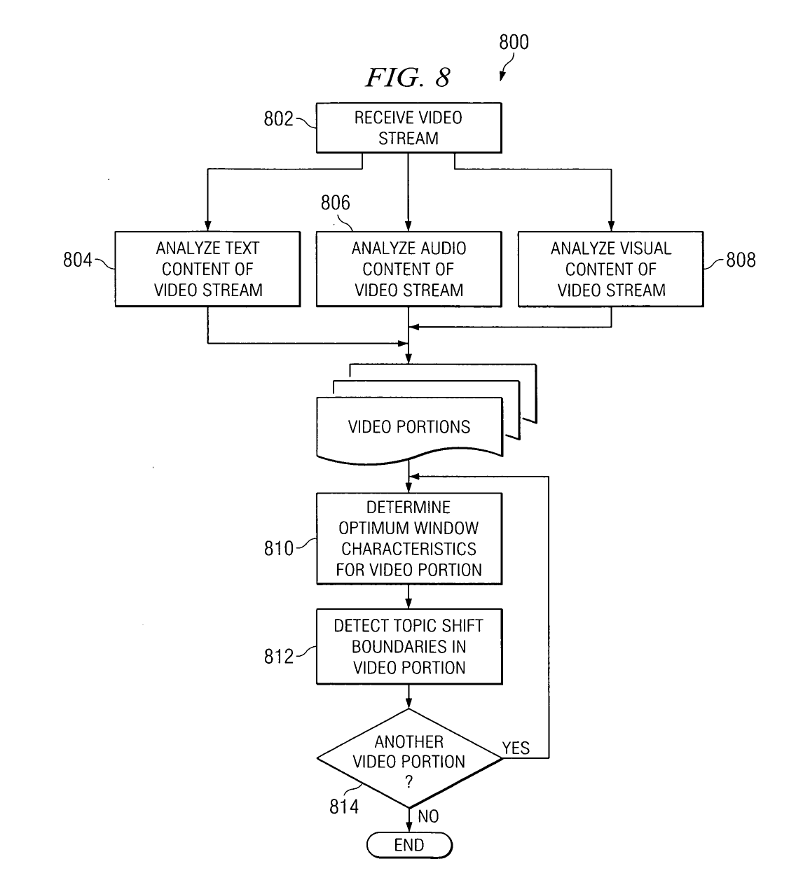

FIG. 8 is a flowchart that illustrates a method for detecting topic shift boundaries in a video stream using joint audio, visual and text information according to an exemplary embodiment. The method is generally designated by reference number 800, and begins by receiving a multimedia stream to be analyzed (Step 802). In the exemplary embodiment illustrated in FIG. 8, the multimedia stream is a video stream. Multimodal analysis is then performed on the video stream. In particular, the text content, the audio content and the visual content of the received video stream are analyzed as shown at Steps 804, 806 and 808, respectively, to recognize various cues in the video stream to identify temporal positions in the video stream at which topic changes have an increased likelihood of occurring to provide a sequence of video portions of the video stream having potential topic changes therebetween. It should be noted that the order in which Steps 804, 806 and 808 are performed is not significant and, in fact, the steps may be performed simultaneously. Also, it should be recognized that it is not necessary to analyze each of the text, audio and visual content of the video stream. For example, a particular video stream may not contain video text overlays or scene texts, and it would not be useful to attempt to analyze the video text content in such a case (for example, module 604 in FIG. 6). Also, it should be recognized that other types of audio, visual and text information in addition to or instead of those mentioned in the embodiment can be applied to recognize cues in a multimedia stream and it is not intended to limit exemplary embodiments to any particular types of features. For example, professionally produced videos may have transition frames at the end of a segment such as a fade, a wipe or other content transition effect such as video transition effects on adjacent segments on the video stream and image transition effects on adjacent images in the video stream that can indicate a topic shift.

Optimized window characteristics are then determined for a sliding window for a first video portion of the sequence of video portions (Step 810). As described above, this determination can be done dynamically by calculating the optimized window size and/or the extent of overlap between windows on the condition that the last window fully resides within the portion and does not cross the boundary of the portion. Topic shift boundaries are then detected in the first video portion using the sliding window having the determined characteristics for the window portion (Step 812).

A determination is then made whether there is another video portion in the video stream (Step 814). If there is another video portion (a ‘Yes’ output of Step 814), the method returns to Step 810 to analyze another video portion. If there are no more video portions in the video stream (a ‘No’ output of Step 814), the method ends.

Exemplary embodiments thus provide a computer implemented method, system and computer usable program code for detecting topic shift boundaries in a multimedia stream. A computer implemented method for detecting topic shift boundaries in a multimedia stream includes receiving a multimedia stream, and performing multimodal analysis on the multimedia stream to locate a plurality of temporal positions within the multimedia stream at which topic changes have an increased likelihood of occurring to provide a sequence of multimedia portions. Characteristics for a sliding window for each multimedia portion in the sequence of multimedia portions are determined, and topic shift boundaries are detected in each multimedia portion by applying a text-based topic shift detector over the media stream's text transcript using a sliding window, wherein the sliding window used with each multimedia portion has the characteristics specially determined from its respective multimedia portion.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for detecting topic shift boundaries in a multimedia stream, the computer implemented method comprising:
receiving a multimedia stream;
performing analysis on the multimedia stream using a plurality of cues to locate a plurality of temporal positions within the multimedia stream to provide a sequence of multimedia portions;
determining characteristics for a sliding window for each multimedia portion in the sequence of multimedia portions; and
detecting topic shift boundaries in each multimedia portion by applying a text-based topic shift detector over a text transcript of the media stream using a sliding window, wherein the sliding window used with each multimedia portion has the characteristics determined from its respective multimedia portion.

2. The computer implemented method according to claim 1, wherein receiving a multimedia stream, comprises:
receiving a video stream having visual information and at least one of audio information and text information.

3. The computer implemented method according to claim 2, wherein performing analysis on the video stream, comprises:
performing visual analysis and at least one of audio analysis and text analysis on the video stream to locate a plurality of temporal positions within the video stream at which topic changes have an increased likelihood of occurring to provide a sequence of video portions.

4. The computer implemented method according to claim 3, wherein performing text analysis on the video stream comprises:
at least one of detecting text cue words or phrases from a time-stamped closed caption or speech transcript of the video stream, and extracting discourse cues from a formatted text obtained from a transcription of the video stream.

5. The computer implemented method according to claim 3, wherein the video stream does not contain audio information, and wherein performing text analysis on the video stream comprises using a transcript of the video stream for performing text analysis on the video stream.

6. The computer implemented method according to claim 5, wherein the transcript comprises a time-stamped transcript generated from at least one of subtitle extraction and manual transcription.

7. The computer implemented method according to claim 3, wherein the video stream contains audio information, and wherein performing an analysis on the video stream comprises generating a text transcript of the video stream using at least one of closed caption extraction and speech recognition.

8. The computer implemented method according to claim 1, wherein determining characteristics for a sliding window for each multimedia portion in the sequence of multimedia portions, comprises:
calculating at least one of an optimum size for a sliding window and an amount of overlap between adjacent sliding windows for each multimedia portion in the sequence of multimedia portions.

9. The computer implemented method according to claim 8, wherein calculating one of an optimum size for a sliding window and an amount of overlap between adjacent sliding windows for each multimedia portion in the sequence of multimedia portions, comprises:
calculating at least one of an optimum size for a sliding window and an amount of overlap between adjacent sliding windows for each multimedia portion in the sequence of multimedia portions such that the last sliding window of each multimedia portion fully resides in its respective multimedia portion.

10. The computer implemented method according to claim 9, wherein calculating at least one of an optimum size for a sliding window and an amount of overlap between adjacent sliding windows for each multimedia portion in the sequence of multimedia portions such that the last sliding window of each multimedia portion fully resides in its respective multimedia portion, further comprises:
calculating at least one of an optimum size for a sliding window and an amount of overlap between adjacent sliding windows for each multimedia portion in the sequence of multimedia portions such that a last sliding window of each multimedia portion ends at a boundary defining the end of its respective multimedia portion.

11. The computer implemented method according to claim 3, wherein performing visual analysis on the video stream comprises:
locating at least one of places in the video stream where video text changes and a macro-segment boundary resides, wherein a macro-segment comprises a semantic unit relating to a thematic topic that is created by detecting and merging a plurality of groups of semantically related and temporally adjacent homogeneous units in accordance with results of any one of audio and visual analysis, and keyword extraction.

12. The computer implemented method according to claim 3, wherein performing visual analysis on the video stream comprises detecting at least one content transition effect including at least one of a video transition effect on adjacent segments on the video stream and an image transition effect on adjacent images in the video stream.

13. The computer implemented method according to claim 3, wherein performing audio analysis on the video stream comprises:
detecting at least one of a long period of silence, a period of music and a change in an audio prosodic feature in the video stream.

14. The computer implemented method according to claim 3, wherein performing audio analysis on the video stream comprises:
detecting a change of speaker in the video stream.

15. The computer implemented method according to claim 3, and further comprising:
performing video macro-segment detection on the video stream using at least one of the visual, audio and text analysis of the video stream to detect macro-segment boundaries in the video stream such that each multimedia portion resides within the boundaries defining the beginning and the end of its respective macro-segment, wherein a macro-segment comprises a semantic unit relating to a thematic topic that is created by detecting and merging a plurality of groups of semantically related and temporally adjacent homogeneous units in accordance with results of any one of audio and visual analysis and keyword extraction.

16. A computer program product, comprising:
a computer usable medium having computer usable program code configured for detecting topic shift boundaries in a multimedia stream, the computer program product comprising:
computer usable program code configured for receiving a multimedia stream;
computer usable program code configured for performing analysis on the multimedia stream using a plurality of cues to locate a plurality of temporal positions within the multimedia stream to provide a sequence of multimedia portions;
computer usable program code configured for determining characteristics for a sliding window for each multimedia portion in the sequence of multimedia portions; and
computer usable program code configured for detecting topic shift boundaries in each multimedia portion by applying a text-based topic shift detector over a text transcript of the video stream using a sliding window, wherein the sliding window used with each multimedia portion has the characteristics determined from its respective multimedia portion.

17. The computer program product according to claim 16, wherein the computer usable program code configured for receiving a multimedia stream, comprises:
computer usable program code configured for receiving a video stream having visual information and at least one of audio information and text information.

18. The computer program product according to claim 17, wherein the computer usable program code configured for performing analysis on the video stream, comprises:
computer usable program code configured for performing visual analysis and at least one of audio analysis and text analysis on the video stream to locate a plurality of temporal positions within the video stream at which topic changes have an increased likelihood of occurring to provide a sequence of video portions.

19. The computer program product according to claim 18, wherein the computer usable program code configured for performing text analysis on the video stream comprises:
computer usable program code configured for at least one of detecting text cue words or phrases from a time-stamped closed caption or speech transcript of the video stream, and extracting discourse cues from a formatted text obtained from a transcription of the video stream.

20. The computer program product according to claim 19, wherein the video stream does not contain audio information, and wherein the computer usable program code configured for performing text analysis on the video stream comprises using a transcript of the video stream for performing text analysis on the video stream, wherein the transcript comprises at least one of a time-stamped transcript generated from subtitle extraction and a manual transcription.

21. The computer program product according to claim 18, wherein the video stream contains audio information, and wherein the computer usable program code configured for performing an analysis on the video stream comprises computer usable program code configured for generating a text transcript of the video stream using at least one of closed caption extraction and speech recognition.

22. The computer program product according to claim 16, wherein the computer usable program code configured for determining characteristics for a sliding window for each multimedia portion in the sequence of multimedia portions, comprises:
computer usable program code configured for calculating at least one of an optimum size for a sliding window and an amount of overlap between adjacent sliding windows for each multimedia portion in the sequence of multimedia portions.

23. The computer program product according to claim 22, wherein the computer usable program code configured for calculating one of an optimum size for a sliding window and an amount of overlap between adjacent sliding windows for each multimedia portion in the sequence of multimedia portions, comprises:
computer usable program code configured for calculating at least one of an optimum size for a sliding window and an amount of overlap between adjacent sliding windows for each multimedia portion in the sequence of multimedia portions such that the last sliding window of each multimedia portion fully resides in its respective multimedia portion and ends at a boundary defining the end of its respective multimedia portion.

24. The computer program product according to claim 18, wherein the computer usable program code configured for performing visual analysis on the video stream comprises:
computer usable program code configured for locating at least one of places in the video stream where video text changes and a macro-segment boundary resides, wherein a macro-segment comprises a semantic unit relating to a thematic topic that is created by detecting and merging a plurality of groups of semantically related and temporally adjacent homogeneous units in accordance with results of at least one of audio and visual analysis, and keyword extraction.

25. The computer program product according to claim 18, wherein the computer usable program code configured for performing visual analysis on the video stream comprises computer usable program code configured for detecting at least one content transition effect including at least one of a video transition effect on adjacent segments on the video stream and an image transition effect on adjacent images in the video stream.

26. The computer program product according to claim 18, wherein the computer usable program code configured for performing audio analysis on the video stream comprises:
computer usable program code configured for detecting at least one of a long period of silence, a period of music, a change in an audio prosodic feature in the video stream, and a change of speaker in the video stream.

27. The computer program product according to claim 18 and further comprising:
computer usable program code configured for performing video macro-segment detection on the video stream using at least one of the visual, audio and text analysis of the video stream to detect macro-segment boundaries in the video stream such that each multimedia portion resides within the boundaries defining the beginning and the end of its respective macro-segment, wherein a macro-segment comprises a semantic unit relating to a thematic topic that is created by detecting and merging a plurality of groups of semantically related and temporally adjacent homogeneous units in accordance with results of at least one of audio and visual analysis, and keyword extraction.

28. A system for detecting topic shift boundaries in a multimedia stream, comprising:
an analyzer unit for performing analysis on a multimedia stream using a plurality of cues to locate a plurality of temporal positions within the multimedia stream to provide a sequence of multimedia portions;
an optimized window determination unit for determining characteristics for a sliding window for each multimedia portion in the sequence of multimedia portions; and
a topic shift detection unit for detecting topic shift boundaries in each multimedia portion by applying a text-based topic shift detector over a text transcript of the video stream using a sliding window, wherein the sliding window used with each multimedia portion has the characteristics determined from its respective multimedia portion.

29. The system according to claim 28, wherein the multimedia stream comprises a video stream having visual information and at least one of audio information and text information.

30. The system according to claim 29, wherein the analyzer unit comprises:
a visual content analyzer for performing visual analysis, and at least one of an audio content analyzer for performing audio analysis on the video stream and a text content analyzer for performing text analysis on the video stream to locate a plurality of temporal positions within the video stream at which topic changes have an increased likelihood of occurring to provide a sequence of video portions.

31. The system according to claim 28, wherein the optimized window determination unit comprises a calculator for calculating at least one of an optimum size for a sliding window, and an amount of overlap between adjacent sliding windows for each multimedia portion in the sequence of multimedia portions such that the last sliding window of each multimedia portion fully resides in its respective multimedia portion and such that a last sliding window of each multimedia portion ends at a boundary defining the end of its respective multimedia portion.

32. The system according to claim 30, wherein the text analyzer comprises at least one of a detector for detecting text cue words or phrases from a time-stamped closed caption or speech transcript of the video stream, and an extractor for extracting discourse cues from a formatted text obtained from a transcription of the video stream.

33. The system according to claim 30, wherein the visual content analyzer comprises a detection mechanism for detecting at least one of places in the video stream where video text changes, at least one content transition effect comprising at least one of a video transition effect on adjacent segments on the video stream and an image transition effect on adjacent images in the video stream occurs, and where a macro-segment boundary resides, wherein a macro-segment comprises a semantic unit relating to a thematic topic that is created by detecting and merging a plurality of groups of semantically related and temporally adjacent homogeneous units in accordance with results of any one of audio and visual analysis and keyword extraction.

34. The system according to claim 30, wherein the audio content analyzer comprises a detector for detecting at least one of a long period of silence, a period of music, a change in an audio prosodic feature in the video stream, and a change of speaker in the video stream.

35. A data processing system for detecting topic shift boundaries in a multimedia stream, the data processing system comprising:
a storage device, wherein the storage device stores computer usable program code; and
a processor, wherein the processor executes the computer usable program code to perform an analysis on a received multimedia stream using a plurality of cues to locate a plurality of temporal positions within the multimedia stream to provide a sequence of multimedia portions, to determine characteristics for a sliding window for each multimedia portion in the sequence of multimedia portions, and to detect topic shift boundaries in each multimedia portion by applying a text-based topic shift detector over a text transcript of the video stream using a sliding window, wherein the sliding window used with each multimedia portion has the characteristics determined from its respective multimedia portion.
